(19) United States
(12) Patent Application Publication
(10) Pub. No.: US 2026/0260970 A1
(43) Pub. Date: Sep. 3, 2026

(54) LONG-DURATION CATHODE MATERIALS

(71) Applicant: Worcester Polytechnic Institute, Worcester, MA (US)

(72) Inventors: Xiaowei Teng, Durham, NH (US); Divakar Arumugam, Worcester, MA (US); Tongxin Zhou, Worcester, MA (US)

(21) Appl. No.: 19/555,313

(22) Filed: Mar. 3, 2026

Related U.S. Application Data
(60) Provisional application No. 63/765,852, filed on Mar. 3, 2025.

(51) Int. Cl. H01M 12/04; H01M 4/90

(52) U.S. Cl. CPC H01M 12/04; H01M 4/9016; H01M 2300/0014

(57) ABSTRACT

A metal-air battery formed from a tri-functional Ni-based composite materials as the cathode and an overloaded iron or zinc electrode as an anode combines Ni—Fe (or Zn—Fe) and Fe-air (or Zn-air) electrochemical approaches, allowing the battery system to be charged and discharged consecutively via Ni—Fe (or Zn—Fe) and Fe-air (or Zn-air) battery modes. The tri-functional Ni-based materials have active Ni₂+/Ni₃+redox reaction to serve as cathode materials for the Fe—Ni (or Zn-Ni) battery component, and beneficial electrocatalytic performance for an Oxygen Evolution Reaction (OER) and Oxygen Reduction Reaction (ORR) to serve as the bifunctional oxygen catalysts in the Fe-air (or Zn-air) battery cathode. A hybrid approach thus optimizes efficiency, cycle life, and cost-effectiveness by leveraging the strengths of both technologies.

### RELATED APPLICATIONS

This patent application claims the benefit under 35 U.S.C. § 119(e) of U.S. Provisional Patent App. No. 63/765,852 filed Mar. 3, 2025, entitled “LONG-DURATION CATHODE MATERIALS,” incorporated herein by reference in entirety.

### BACKGROUND

Batteries are devices for storing and releasing electrical energy (power) from an electrochemical reaction. Conventional electrical power is often produced from electromechanical reactions, often from a moving or rotating magnetic source in coil of wire. The magnetic source may be rotated by a fossil fuel powered engine, steam turbine, water driven turbine, or wind driven propeller (windmill). Once generated, electrical energy may be stored in a battery, if not immediately consumed. Intermittent solar and wind sourced electromechanical energy can direct the electric energy to batteries for subsequent delivery. Electrochemical reactions generate an electrical flow based on electron transfer in a chemical reaction, usually from redox (reduction/oxidation) reactions involving ions.

### SUMMARY

A metal-air hybrid battery formed from a tri-functional Ni-based composite materials as the cathode and an overloaded iron or zinc electrode as an anode combines Ni—Fe (or Zn—Fe) and Fe-air (or Zn-air) electrochemical approaches, allowing the battery system to be charged and discharged consecutively via Ni—Fe (or Zn—Fe) and Fe-air (or Fe-air) battery modes. The tri-functional Ni-based materials have active Ni²⁺/Ni³⁺redox reaction to serve as cathode materials for the Fe—Ni (or Zn—Ni) battery component, and beneficial electrocatalytic performance for an Oxygen Evolution Reaction (OER) and Oxygen Reduction Reaction (ORR) to serve as the bifunctional oxygen catalysts in the Fe-air (or Zn-air) battery cathode. The disclosed hybrid approach thus optimizes efficiency, cycle life, and cost-effectiveness by leveraging the strengths of both technologies.

Configurations herein are based, in part on the observation that modern battery technology is substantially focused on high power discharge for electric vehicle (EV) use, typically involving lithium ion battery chemistry. Unfortunately, conventional approaches suited to EV usage suffer from the shortcoming that they do not conform well to stationary, longer term usage such as electrical grid backup and storage. Charge longevity and lowered, scalable costs are preferable for grid storage, and the high power density and rapid discharge features of Li chemistries are more amenable to the mobility needs of EVs.

Accordingly, configurations herein substantially overcome the shortcomings of conventional battery chemistry technologies for longer term and stationary grid storage by providing a multi-functional cathode material operable for multiple charge/discharge modes in an iron-air battery having deep cycle discharge and charge cycle longevity capable of many recharge cycles. The disclosed high-efficiency and long-duration metal-air hybrid alkaline battery chemistry uses iron (Fe)-or zinc (Zn)-based materials as the anode and the tri-functional nickel-based materials as the cathode (when operated as a metal-nickel battery), or oxygen catalyst for oxygen evolution and reduction reactions (when operated as a metal-air battery) in a tight-packing, compact alkaline cell.

In further detail, an energy storage device having a plurality of layers for storage and delivery of electric energy includes a multi-function catalyst cathode including a metal hydroxide compound configured for redox reactions for a plurality of conjugate redox pairs, and a porous current collector configured for passage of at least one of the conjugate redox pairs. A separator, an anode and an anode current collector on an opposed side of the multi-function catalyst from the porous current collector complete the full battery cell for hybrid operation.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a diagram of a conventional (prior art) oxygen redox battery;

FIGS. 2A-2B are a schematic diagram of an iron-air battery having a tri-functional electrode/catalyst suitable for use with configurations herein;

FIGS. 3A-3B show a zinc-air battery with the tri-functional electrode/catalyst;

FIGS. 4A-4C show alternate configurations of an air cathode battery as in FIGS. 2A-3B;

FIGS. 5A-5B show dual sided air cathode batteries as in FIGS. 4B-4C;

FIGS. 6A-6E show cycling performance graphs of charge/discharge cycles of the tri-functional cathodes as in FIGS. 2A-5B; and

FIGS. 7A-7D show use cases of various nickel compounds in the tri-functional cathodes

### DETAILED DESCRIPTION

Energy storage technologies are critical for integrating renewable energy and enabling resilient, sustainable power systems. Among candidate chemistries for grid-scale deployment, alkaline metal-air batteries based on earth-abundant metals such as iron (Fe) and zinc (Zn) offer a compelling combination of low cost, safety, and scalability. Iron is the fourth most abundant element in the Earth's crust, while zinc is the 24th and widely produced globally. Both metals are redox-active in alkaline media and have long-standing industrial supply chains, making them attractive anode materials for large-scale applications.

Both Fe—air and Zn-air chemistries leverage earth-abundant, non-critical metals and safe aqueous electrolytes. Together, alkaline iron-air and zinc-air batteries represent complementary platforms for cost-effective, safe, and scalable grid energy storage.

Specifically, iron systems excel in ultra-low cost, dendrite-free behavior, and compatibility with upcycled materials, making them especially attractive for multi-day or long-duration storage, including the following beneficial features:
(1) Low manufacturing and raw material cost: Iron alkaline batteries avoid flammable organic electrolytes and the water-and air-sensitive dry-room environments required for lithium-ion battery manufacturing. Iron is a commodity metal produced at multi-million-ton scale, resulting in low and stable raw material costs compared to critical materials such as cobalt or nickel.
(2) Intrinsic safety: Fe-based systems employ aqueous alkaline electrolytes, eliminating fire risks associated with organic solvents. This makes them particularly attractive for stationary storage in safety-critical environments such as hospitals, data centers, schools, factories, and warehouses.
(3) Dendrite-free operation: Iron undergoes solid-solid conversion reactions among Fe, Fe(OH)₂, Fe₃O₄, and FeOOH. These phases exhibit extremely low solubility in mild alkaline electrolytes, minimizing metal dissolution and suppressing dendrite growth. As a result, expensive ion-selective membranes are unnecessary in iron-air configurations.
(4) Upcycling opportunity: The U.S. generates over 15 million tons of scrap iron annually, much of it in oxidized forms such as Fe₂O₃·H₂O and FeOOH (rust). Rechargeable alkaline iron-air batteries can directly leverage these hydrous iron oxides as active materials, transforming industrial waste into grid-scale energy storage assets while revitalizing century-old iron battery chemistry for modern decarbonization needs.

Zinc anodes are widely used in Zinc-air battery systems and represent one of the most mature metal-air technologies, and exhibit::
(1) High theoretical capacity and energy density: Zinc offers a high theoretical gravimetric capacity (~820 mAh g⁻¹) and favorable electrochemical potential in alkaline electrolytes, enabling high energy density in both primary and rechargeable Zn-air systems.
(2) Established industrial infrastructure: Zinc mining, refining, and recycling infrastructures are globally established, offering stable pricing. Zinc-air technology has already been commercialized in primary formats (e.g., hearing aids), providing a solid foundation for rechargeable development.
(3) Aqueous safety and environmental compatibility: Like iron systems, Zn-air batteries use aqueous alkaline electrolytes, avoiding flammable solvents and offering intrinsic safety advantages for stationary storage.

Common shortcomings of conventional air batteries result because the oxygen electrode (air cathode) is both the activating component and the principal bottleneck in rechargeable alkaline metal-air batteries (e.g., Fe-air and Zn-air systems). Unlike conventional intercalation cathodes, the oxygen electrode must catalyze two kinetically sluggish reactions: the oxygen reduction reaction (ORR) during discharge and the oxygen evolution reaction (OER) during charge. The large overpotentials associated with ORR/OER lead to significant voltage gaps, low round-trip efficiency, and heat generation—often dominating overall cell losses even when the metal anode operates efficiently. These key challenges arise from:
(1) Sluggish four-electron transfer kinetics,
(2) Catalyst degradation under highly oxidative OER conditions,
(3) Carbonate formation from CO₂ in ambient air that blocks active sites,
(4) Flooding or drying of the porous electrode further destabilizes performance, while catalyst detachment and carbon corrosion shorten cycle life.

Addressing the limitations of oxygen electrodes is therefore pivotal to accelerate the commercialization of alkaline metal-air batteries for grid-scale storage. Several research directions have been focused on addressing these challenges, including:
(1) Advances in bifunctional catalysts—such as spinel oxides, perovskites, and transition-metal hydroxides—are narrowing the ORR/OER overpotential gap.
(2) Rational electrode architectures integrating hierarchical porosity and robust hydrophobic binders can enhance oxygen diffusion while maintaining electrolyte access.
(3) Decoupled or redox-mediated designs (e.g., using soluble redox shuttles) offer pathways to spatially or temporally separate ORR and OER, mitigating catalyst stress.
(4) Employing non-precious, earth-abundant catalysts aligns with the low-cost philosophy of Fe-and Zn-based systems.

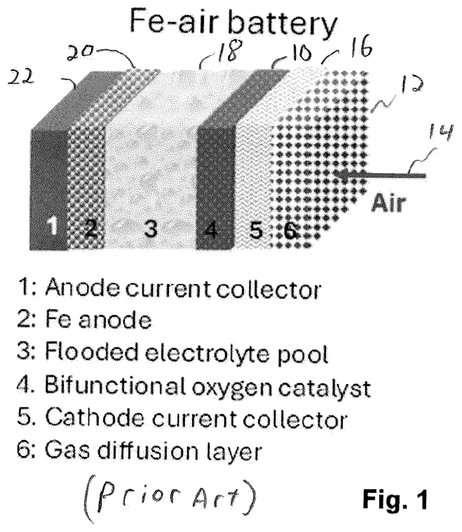

FIG. 1 is a diagram of a conventional oxygen redox battery. In a conventional alkaline metal-air batteries (e.g., Fe-air and Zn-air systems), as shown in FIG. 1, an oxygen electrode 10 or catalyst operates as the cathode adjacent a current collector 16 and is both the enabling component and the primary bottleneck. It must catalyze the oxygen reduction reaction (ORR) during discharge and the oxygen evolution reaction (OER) during charge—two kinetically sluggish, multi-electron processes that introduce large overpotentials and limit round-trip efficiency. Catalyst degradation and mass transport limitations in gas diffusion electrodes (GDEs) further compromise durability and rate capability.

A gaseous diffusion layer 12 allows entry of oxygen from ambient air 14 for oxygen redox (ORR/OER) via the electrode 10, which operates as a bifunctional (ORR/OER) oxygen catalyst for establishing a voltage/current flow via the cathode current collector. An electrolyte pool 18, coupled with an anode 20 (typically iron) and anode current collector 22 completes the charge/discharge circuit in conjunction with an appropriate load/charge source.

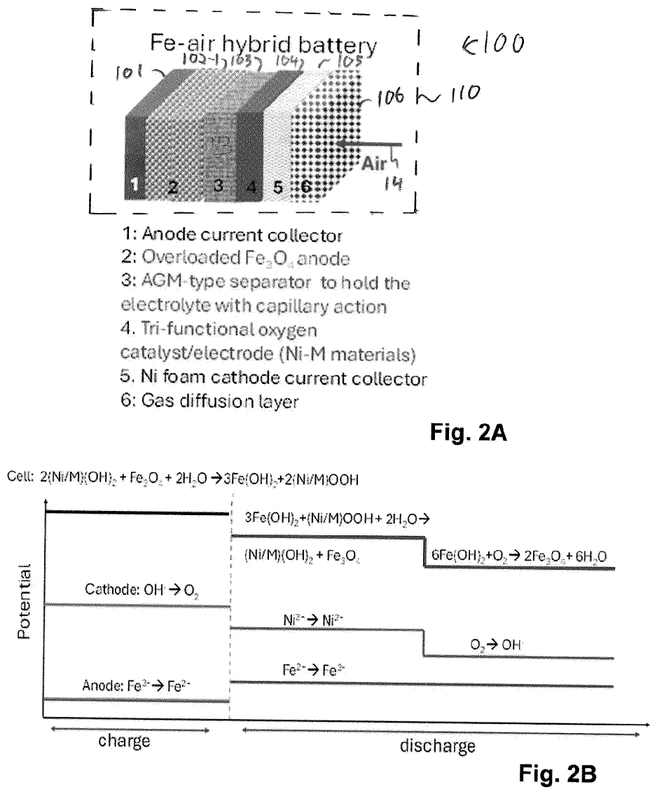

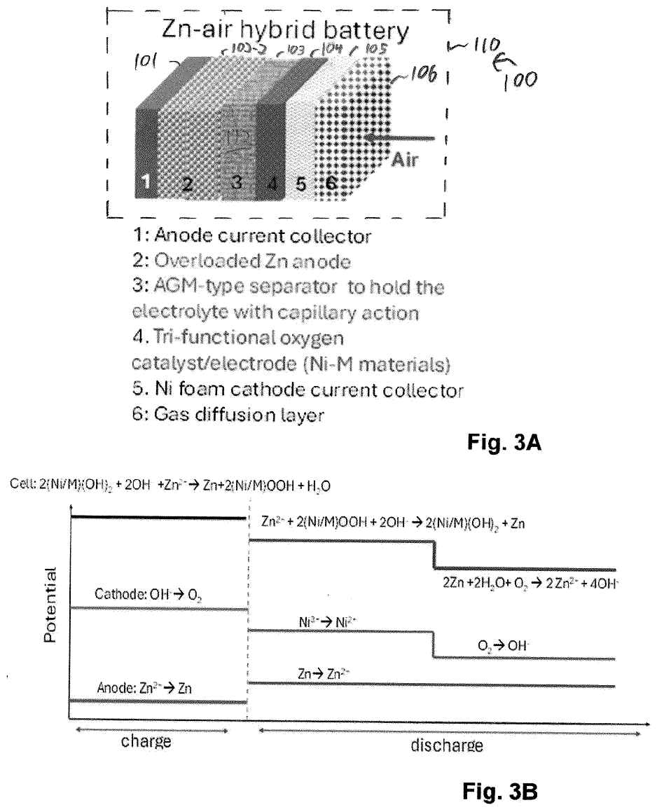

FIGS. 2A-2B are a schematic diagram of an iron-air battery having a tri-functional electrode/catalyst 104 suitable for use with configurations herein. Referring to FIGS. 2A-3B, and in contrast to FIG. 1, the configuration of FIG. 2A-B relate to an Fe-Air and FIGS. 3A-3B depict a Zn-Air hybrid alkaline battery that uses an overloaded iron (or Zn) anode 102 electrode as the anode and tri-functional Ni-based composite materials as the cathode 104. An energy storage device 100 has a plurality of layers 101-106 for storage and delivery of electric energy, and include a multi-function catalyst cathode 104 including a metal hydroxide compound configured for redox reactions for a plurality of conjugate redox pairs, adjacent a porous current collector 105 configured for passage of at least one of the conjugate redox pairs. A separator 103 containing an electrolyte 112, anode 102 and an anode current collector 101 on an opposed side of the multi-function catalyst from the porous current collector 105, typically enclosed in a casing or containment 110, form a functional battery 100.

As shown in FIGS. 2A and 3A, the cathode 104 is defined by layer of tri-functional Ni-based materials for providing both:
(1) active Ni²⁺/Ni³⁺redox reaction to as cathode materials for Fe—Ni (FIG. 2A-B) or Zn—Ni (FIG. 3A-B) battery chemistry redox reaction, and
(2) beneficial electrocatalytic performance for OER and ORR to serve as the bifunctional oxygen catalysts in the Fe-air or Zn-air battery cathode.

The configuration of FIGS. 2A-3B includes the tri-functional oxygen electrode 104 (cathode) that integrates ORR, OER, and reversible nickel redox (Ni²+/Ni³+) . In addition to catalyzing OER/ORR for high-energy storage, the embedded Ni(OH)₂/NiOOH redox couple provides a fast, surface-controlled faradaic reaction that enables high-power operation, as shown in FIGS. 2B and 3B. The porous current 105 collector is a hybrid current collector configured for transport of gaseous oxygen supporting both the oxygen evolution reaction and an oxygen reduction reaction, and also transport of ions for a metal salt redox. This dual pathway design decouples energy and power functions by providing:
High energy density governed by the metal-air chemistry (Fe or Zn coupled with ORR/OER); and
High power density supported by rapid metal-Ni redox chemistry (Fe or Zn coupled with Ni redox), which buffers transient loads and reduces polarization at high current densities.

The overall operating approach of FIGS. 2A and 3A are the combination of high-energy catalytic oxygen chemistry with the high-power Ni redox, such that the tri-functional oxygen cathode 104 transforms the traditional air cathode from a kinetic bottleneck into a multifunctional energy-power management platform, advancing alkaline metal-air batteries toward both long-duration and high-rate grid applications.

In implementation, the Fe-Air and Zn-air hybrid battery 100 comprises a vessel or containment 110 in which the electrolyte, cathode, anode, and diaphragm separator are assembled in a lamination-type structure 100 where the separator 103 isolates the anode 102 and cathode 104 plates, or layers. FIGS. 2B and 3B show the corresponding electrochemical reactions.

Continuing to refer to FIG. 2A-3B, the anode includes an iron-based 102-1 or Zn-based 102-2 (102 generally) material that is used to produce an anode whether starting as metallic iron, metallic zinc, iron-oxide, zinc-oxides, and various combinations of metal and ceramics. These can be sintered, plated, reduced, or compacted powders. These iron and zinc-based materials also include alloys of other elements up to 10% by weight of alloying elements. These alloying materials may include one or more of the following elements: Aluminum (Al), Antimony (Sb), Bismuth (Bi), Calcium (Ca), Copper (Cu), Indium (In), Lead (Pb), Nickel (Ni), Sulfur (S), and Tin (Sn). The overloading of the anode 102 refers to a loading of anode material is higher than that of Ni-based material in the cathode 104, designating the mass of anode active materials as nM and cathode active materials loading as M (n≥1).

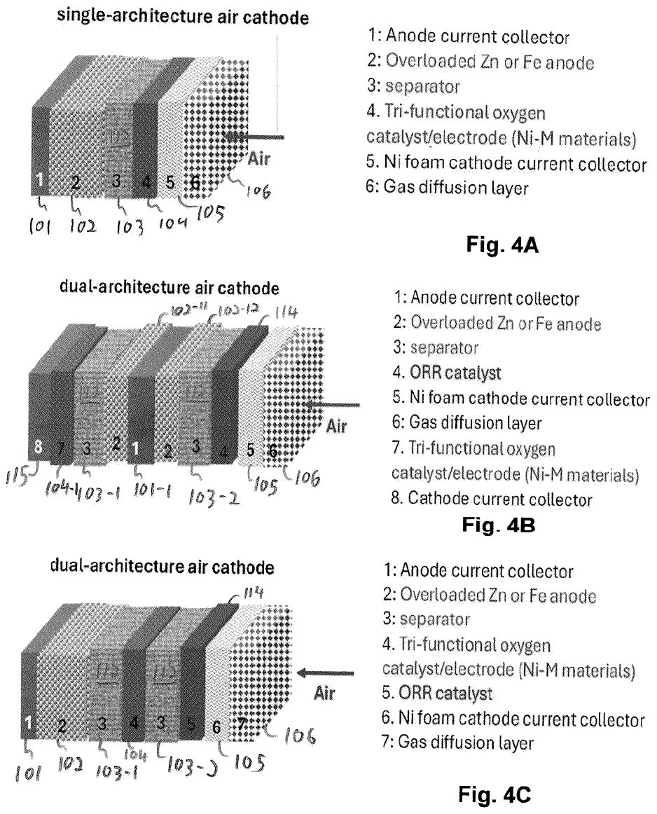

FIGS. 4A-4C show alternate configurations of an air cathode battery as in FIGS. 2A-3B, generally by alternating or rearranging the layers 101 . . . 106. Referring to FIG. 4A the cathode 104 can be a single-architecture air cathode, selected based on conjugate redox pairs that include a gaseous species and a metal species, thus forming a tri-functional oxygen electrode 104 that integrates ORR, OER, and reversible nickel redox (Ni²⁺/Ni³⁺) , as shown in FIG. 4A. Thus, in a typical configuration, the plurality of conjugate redox pairs include a nickel redox species and an oxygen redox species. This innovative tri-functional cathode is Ni-based hydroxides or oxide [(Ni/M)(OH)₂, (Ni/M)_{X}O_{Y}], M can be Ni, Fe, Al, the Ni:M molar ratio can range from 2:1 to 20:1, X can be 1 or 2 or 3, and Y can be 1 or 2 or 3 or 4,, including Ni—Fe hydroxide or oxide and Ni—Al hydroxide or oxide.

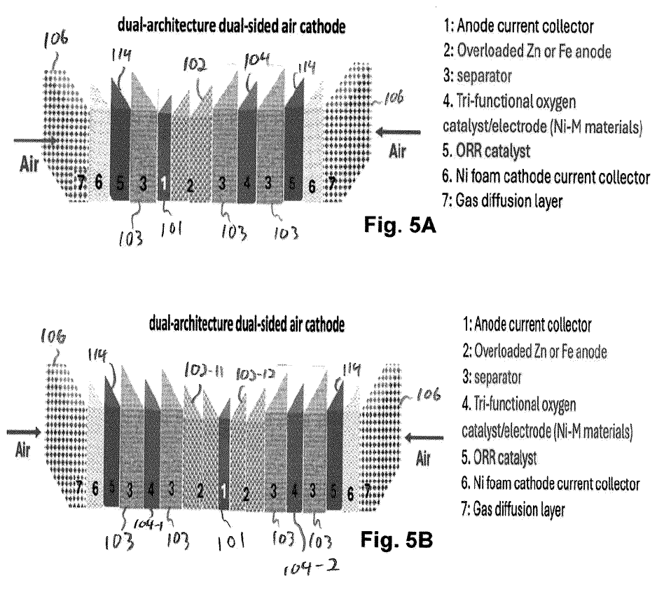

FIG. 4B depicts that the cathode may also be a dual-architecture air cathode, namely, an ORR-active catalyst 114 and a tri-functional (Ni/M)(OH)₂ or (Ni/M)_{X}O_{Y} material 104. In this design, the ORR-active catalyst 114 and tri-functional materials 104-1 can be placed on opposite side of the anode 102-11, 102-12 (FIG. 4B), (Fig, 4B and FIGS. 5A-5B, below). The adjacent current collector 115 is distal from the porous Ni current collector 105, which is a nickel based foam, mesh, powder or other suitable material configured for passage of oxygen for an oxygen redox and conduction for a nickel redox. The oxygen catalyst/electrode (Ni-M materials) may be coated, plated, or deposited onto the Ni-based current collector.

The separator 103-1 . . . 103-2 (103 generally) is an electrically insulative, ionically conductive material having a capillary or absorptive retention for an electrolytic fluid 112, and is disposed between the anode 102 and the multi-function catalyst cathode 104. A suitable electrolyte 112 is an alkaline solution (e.g., NaOH with pH ranging from 11 to 14.5) and sodium silicate (Na₂SiO₃) electrolyte additive (with concentration ranging from 0 ppm to 10,000 ppm) and other salts, such as Na₂SO₄, Na₂CO₃, NaCl, K₂SO₄, K₂CO₃, KCl, Li₂SO₄, Li₂CO₃ or LiCl.

The physical separator 103 material may be polypropylene, polyethylene, polyvinyl alcohol, cellulose-based materials (e.g., filter paper), alkali-resistant glass fibers, or combinations of said materials. Separators 103 can also be of the diaphragm film type, which are also electrically insulative and ionically conductive. The diaphragm configuration employs two particular characteristics in the hybrid battery 100 design: Firstly, the rigid diaphragm separators have good mechanical stability, allowing tight packing of electrode/separator assembly. Tight packing presses the electrode surface and reduces internal resistance between the electrode and/or the current collector to reduce the overpotential of the battery cells and improve energy efficiency. Tight packing also reduces the dimension of the cells, improving the volumetric electrochemical matrices of the battery devices. Secondly, diaphragm separators are highly porous, holding a large amount of aqueous electrolytes, in addition to the electrolyte surrounding cell components, due to the capillary force to ensure good electrolyte distribution across the electrode/diaphragm interface and wetting of electrodes.

FIGS. 5A-5B show dual sided air cathode batteries as in FIG. 4A-4C, also by alternate arrangements of layers in the battery 100. Referring to FIGS. 5A and 5B, a dual-architecture air cathode in the proposed Fe-air and Zn-air hybrid alkaline batteries is shown, where the two cathode materials 104-1, 104-2 (cathode) and catalyst 114 and are located at the same side.

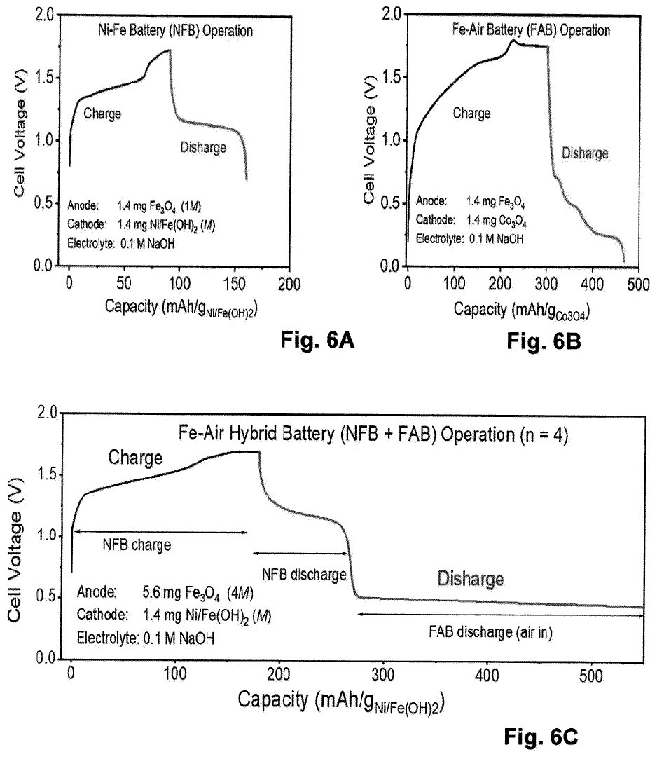

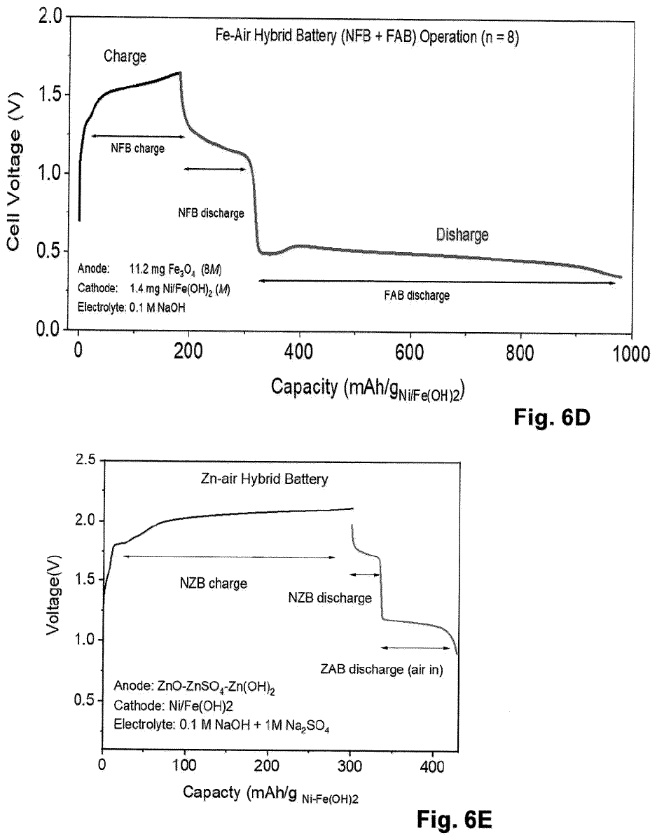

FIGS. 6A-6E show cycling performance graphs of charge/discharge cycles of the tri-functional cathodes as in FIGS. 2A-3B. Referring to FIGS. 2A-6E, in operation of the battery 100, a particular sequence is followed, such that a method of storing and discharging electrical energy in a metal-air battery includes providing a layered cell structured with the multi-function catalyst cathode 104 including a metal hydroxide compound configured for redox reactions for a plurality of conjugate redox pairs, and the porous current collector 105 configured for passage of at least one of the conjugate redox pairs. The anode 102 is formed from anode materials of one or more of Fe, Fe(OH)₂, FeOOH and Fe₃O₄. The multi-function catalyst cathode 104 generally includes a hydroxide or oxide of compounds selected from the group consisting of Ni, Al, and Fe, where the hydroxide or oxide is selected for an oxygen redox capability. The overloaded anode 102 is therefore formed from an iron or zinc compound having a mass equal to or greater than a mass of the multi-function catalyst cathode 104.

During Fe-Air hybrid battery operation, anode starting materials are typically Fe, Fe(OH)₂, FeOOH or Fe₃O₄ or a mixture of two at any ratio. However, they can also be FeOOH, Fe₃O₄, Fe(OH)₂, or Fe or a mixture of three or four at any ratio. The starting materials at the cathode are the tri-functional Ni/M(OH)₂ or (Ni/M)_{X}O_{Y} (M can be Ni, Fe, Al, the Ni: M molar ratio can range from 2:1 to 20:1, X can be 1 or 2 or 3, and Y can be 1 or 2 or 3 or 4) mixed with MnO₂ (or other commercial ORR catalysts) with a mass loading from zero to equivalent mass of Ni/M(OH)₂ or (Ni/M)_{X}O_{Y} The electrolytes can be NaOH with concentration ranging from 0.001 M to 6 M, and salts, including sodium silicate (0 to 10,000 ppm). Other suitable alkaline electrolytes such as KOH and Li(OH)₂ may also be employed.

In a cell formation phase, the newly built hybrid cell is first formed by a deep charging process, where the anode active materials are fully charged to Fe(OH)₂, and cathode active materials are fully charged to Ni/MOOH at the cathode. Alternatively, the cell can be built utilizing primarily metallic iron in the charged state prior to the first discharge and charge cycle.

As described above, the multifunction electrode 104 layer is configured for operation in one of either nickel-iron battery mode, or iron-air battery mode. In a cell operation phase, in nickel-iron battery (NFB) mode, the hybrid cell 100 can routinely operate in the NFB mode, involving Fe²⁺/Fe³⁺redox in the anode and Ni²⁺/Ni³⁺in the cathode, shown in FIG. 6A. The Fe₃O₄/Fe(OH)₂ redox couple adopted in anode chemistry (i) avoids metallic Fe formation on battery charging and thus mitigates the vigorous water decomposition into unwanted H₂ gas, and (ii) avoids FeOOH formation on battery discharge and thus decreases the overpotential of anode redox (since Fe₃O₄→FeOOH requires more electrical energy input and thus a large overpotential). This new anode chemistry improves the energy efficiency of the battery cell.

Alternatively, cell operation in iron-air battery (FAB) mode proceeds as follows. The hybrid cell can operate in FAB mode when the hybrid cell is required to provide long-duration discharge, especially under an “off-grid” scenario, shown in FIG. 6B. Notably, the “duration” of the FAB mode can be controlled by the loading of Fe₃O₄ active material at the anode. Assuming a suitable discharge time of X hours for Fe₃O₄ anode mass of M, where n=1), the duration of discharging in FAB mode can be up to nX hours when the loading of Fe₃O₄ material at anode is nM.

In a cell re-formation phase, after long-duration “deep discharge” FAB mode, the hybrid cell can start from cell operation, as above, operating in NFB mode (with a typical discharge duration of X hours). However, if the cell is expected to be operated in long-duration “deep discharge” again (with a typical discharge duration of nX hours), the hybrid cell will start from will start from cell reformation. In this embodiment, the n =1, 4, 8 experimental data are presented in FIGS. 6C and 6D, respectively. However, the value for n can be any suitable number.

Turning to Zn-Air hybrid battery operation, the device can be constructed and assembled, as shown in FIGS. 2A-5 above. Anode starting materials are typically Zn, ZnO, Zn(OH)₂, or other Zn compounds or a mixture of materials at any ratio. The starting materials at the cathode are the tri-functional Ni/M(OH)₂ or (Ni/M)_{X}O_{Y} (M can be Ni, Fe, Al, the Ni: M molar ratio can range from 2:1 to 20:1,, X can be 1 or 2 or 3, and Y can be 1 or 2 or 3 or 4) mixed with MnO₂ (or other commercial ORR catalysts) with a mass loading from zero to equivalent mass of Ni/M(OH)₂ or (Ni/M)_{X}O_{Y}. The electrolytes can be NaOH with concentration ranging from 0.001 M to 6M, and salts, including sodium silicate (0 to 10,000 ppm). Any suitable alkaline electrolyte as discussed above may be employed.

In a cell formation phase, the newly built hybrid cell 100 is first formed by a deep charging process, where the anode active materials are fully charged to Zn, and cathode active materials are fully charged to Ni/MOOH at the cathode. Alternatively, the cell can be built in the charged state with primarily metallic Zn prior to the first discharge and charge cycle.

In a cell operation phase in nickel-Zn battery (NZB) mode, the hybrid cell can routinely operate in NZB mode, involving Zn/Zn²⁺ redox in the anode and Ni²⁺/Ni³⁺ in the cathode, shown in FIG. 6E.

For cell operation in a Zn-air battery (ZAB) mode, the hybrid cell can operate in ZAB mode when the hybrid cell is required to provide long-duration discharge, especially under an “off-grid” scenario, shown in FIG. 6E. Notably, the “duration” of the ZAB mode can be controlled by the loading of Zn active material at the anode. Assuming X hours discharge time for Zn anode mass of M, where n=1), the duration of discharge in ZAB mode can be up to nX hours when the loading of Zn material at anode is nM.

A cell re-formation phase occurs after long-duration “deep discharge” ZAB mode, the hybrid cell can start as above, operating in NZB mode (with a typical discharge duration of X hours). However, if the cell is expected to be operated in long duration “deep discharge” again (with a typical discharge duration of nX hours), the hybrid cell will start from cell reformation.

The disclosed hybrid alkaline Fe-air or Zn-air battery system and device provides technological improvements that combine the strengths of both metal-nickel and metal-air battery technologies to create a more efficient, durable, and cost-effective energy storage solution. Beneficial aspects include:
(1) Improved Energy Density: metal-nickel batteries (e.g., Ni—Fe or Ni—Zn batteries are known for their long lifespan and durability but have a relatively low energy density (~50 Wh/kg). On the other hand, metal-air batteries have a significantly higher theoretical energy density (~700-1200 Wh/kg) due to their use of oxygen from the air as a reactant. This innovation reports unique, tri-functional Ni-based materials, allowing metal-nickel and metal-air battery operation hybridization for better energy density and efficiency by leveraging high energy from metal-air battery and robust durability from metal-nickel batteries.
(2) Enhanced Power Performance: The hybridization allows for more flexible power management, with metal-nickel battery operation mode handling peak loads and metal-air battery operation providing steady long-duration storage.
(3) Improved Efficiency: metal-nickel batteries have a moderate RTE (Round Trip Efficiency) of around ~60-70%, largely due to the formation of an electrochemically inactive γ—NiOOH phase that is difficult to reduce to Ni(OH)₂ in the sequential discharge process. The hybridization operation allows supplemental deep discharging, following the sequential reduction of NiOOH and oxygen (ORR). The ORR occurs at a much lower cathodic potential than that of NiOOH reduction, by which γ-NiOOH phase can be fully reduced to Ni(OH)₂ which is normally not attainable during regular NFB operation.

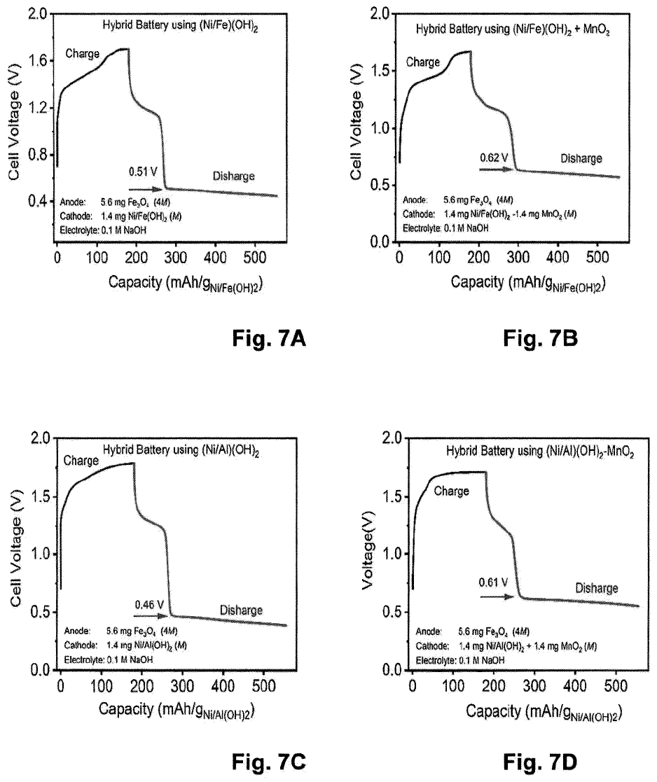

FIGS. 7A-7D show use cases of various nickel compounds in the tri-functional cathodes. Chronoamperometry (CP) curves of the hybrid cells using four different tri-functional cathode materials, including single-architecture air electrode (e.g., Ni_{0.95}Fe_{0.05}(OH)₂, Ni_{0.9}Al_{0.1}(OH)₂) and dual-architecture air electrode (e.g., Ni_{0.95}Fe_{0.05}(OH)₂-MnO₂, and Ni_{0.9}Al_{0.1}(OH)₂-MnO₂). FIG. 7A shows a Ni/Fe(OH)₂ single-architecture air electrode (as in FIG. 4A), FIG. 7B shows a Ni/Fe(OH)₂-MnO₂ dual-architecture air electrode (as in FIG. 4B and FIGS. 5A-5B), FIG. 7C depicts a Ni/Al(OH)₂ single-architecture air electrode (as in FIG. 4A), and FIG. 7D shows a Ni/Al(OH)₂-MnO₂ dual-architecture air electrode (as in FIG. 4B and FIGS. 5A-5B). The example hybrid battery cells use an overloaded Fe₃O₄ anode (4 times more loading than Ni/M(OH)₂ cathode materials, n=4). While single-architecture air electrodes are suitable tri-functional materials with active Ni²⁺/Ni³⁺ redox and OER/ORR performance, dual-architecture air electrode with MnO₂ ORR catalysts further improves the ORR performance (the onset potential of ORR decreases 0.11 V and 0.15 V, respectively).

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. An energy storage device having a plurality of layers for storage and delivery of electric energy, comprising:
a multi-function catalyst cathode including a metal hydroxide compound configured for redox reactions for a plurality of conjugate redox pairs;
a porous current collector configured for passage of at least one of the conjugate redox pairs; and
a separator, an anode and an anode current collector on an opposed side of the multi-function catalyst from the porous current collector.

2. The device of claim 1 wherein the porous current collector is a hybrid current collector configured for transport of gaseous oxygen supporting an oxygen evolution reaction and an oxygen reduction reaction, and transport of ions for a metal salt redox.

3. The device of claim 1 wherein the conjugate redox pairs include a gaseous species and a metal species.

4. The device of claim 1 wherein the multi-function catalyst cathode further comprises a hydroxide of compounds selected from the group consisting of Ni, Al, and Fe, the hydroxide or oxide selected for an oxygen redox capability; and
the anode is formed from an iron or zinc compound having a mass equal to or greater than a mass of the multi-function catalyst cathode.

5. The device of claim 1 wherein the plurality of conjugate redox pairs include a nickel redox species and an oxygen redox species.

6. The device of claim 1 wherein the separator further comprises an electrically insulative, ionically conductive material having a capillary or absorptive retention for an electrolytic fluid, the separator disposed between the anode and the multi-function catalyst cathode.

7. The device of claim 6 wherein the separator is formed from materials including one or more of polypropylene, polyethylene, polyvinyl alcohol, cellulose-based materials, alkali-resistant glass fibers and absorbent glass mat.

8. The device of claim 6 wherein the electrolyte is an alkaline solution having a pH between 11.0-14.5.

9. The device of claim 8 wherein the electrolyte includes salts selected from the group consisting of Na₂SiO₃, Na₂SO₄, Na₂CO₃, NaCl, K₂SO₄, K₂CO₃, KCl., Li₂SO₄, Li₂CO₃ or LiCl.

10. The device of claim 8 wherein the electrolyte is sodium hydroxide with a sodium silicate additive in the range of 0 ppm- 10,000 ppm.

11. A method of storing and discharging electrical energy in a metal-air battery, comprising:
providing a layered cell including:
a multi-function catalyst cathode including a metal hydroxide or oxide compound configured for redox reactions for a plurality of conjugate redox pairs;
a multi-function catalyst cathode mentioned above mixed with MnO₂ (or other commercial ORR catalysts) with a mass loading from zero to equivalent mass of a multi-function catalyst;
a porous current collector configured for passage of at least one of the conjugate redox pairs; and
an anode formed from anode materials of one or more of Fe, Fe(OH)₂, FeOOH, Fe₃O₄, Zn, ZnO, Zn(OH)₂;
deep charging the layered cell for charging the anode materials to Fe(OH)₂;
charging the cathode to cathode to Ni/MOOH or (Ni/M)_{X}O_{Y}, where M is a metal selected from the group consisting of Ni, Fe and Al, X is be 1 or 2 or 3, and Y can be 1or 2 or 3 or 4
operating the cell in a nickel-iron battery mode by performing an Fe²⁺/Fe³⁺ redox in the anode and Ni²⁺/Ni³⁺ redox in the cathode; and
operating the cell in an iron-air battery mode by performing an oxygen redox at the cathode.

12. The method of claim 11 further comprising:
selecting whether a subsequent deep discharge operation is expected; and
performing one of either:
nickel-iron battery mode,
iron-air battery mode,
nickel-zinc battery mode or
zinc-air battery mode, based on the selection.

13. A metal air battery, comprising:
a nickel hydroxide or oxide compound defining a multifunction electrode layer configured for:
i ) a nickel redox reaction,
ii ) an oxygen evolution reaction (OER), and
iii ) an oxygen reduction reaction (ORR);
a cathode current collector layer adjacent the multifunction electrode layer, the cathode current collector formed from a porous nickel material; and
a gaseous diffusion layer on an opposed side of the cathode current collector layer from the multifunction electrode layer, the gaseous diffusion layer configured for passage of O₂;
an overloaded anode layer, the overloaded anode layer including zinc or iron of a greater mass than the nickel compound in the multifunction electrode layer;
a separator layer between the overloaded anode layer and the multifunction electrode layer, the separator layer configured for ionic conduction and fluidic retention; and
an anode current collector on an opposed side of the overloaded anode layer from the separator layer.

14. The device of claim 13 wherein the multifunction electrode layer is configured for operation in one of either nickel-iron battery mode, or iron-air battery mode, or in either nickel-zinc battery mode, or zinc-air battery mode.
